(19) United States
(12) Patent Application Publication
(10) Pub. No.: US 2020/0352812 A1
(43) Pub. Date: Nov. 12, 2020

(54) Traction Device

(71) Applicant: Nicholas Cooper, Indianapolis, IN (US)

(72) Inventor: Nicholas Cooper, Indianapolis, IN (US)

(21) Appl. No.: 16/869,855

(22) Filed: May 8, 2020

Related U.S. Application Data
(60) Provisional application No. 62/844,927, filed on May 8, 2019.

(51) Int. Cl. A61H 1/02

(52) U.S. Cl. CPC A61H 1/0229; A61H 1/0296; A61H 2201/0126; A61H 2203/0481; A61H 2201/0123; A61H 2203/0431

(57) ABSTRACT

The present disclosure provides a traction device mountable on a vertical surface, such as a wall or door. The traction device can be adjusted by a user to alter the amount of tension applied to the user by a harness of the traction device.

### CROSS-REFERENCE TO RELATED APPLICATIONS

The application claims the benefit of U.S. Provisional Application No. 62/844,927, filed on May 8, 2019, and entitled “TRACTION DEVICE,” to Nicholas Cooper, the complete disclosure of which is expressly incorporated by reference herein.

### TECHNICAL BACKGROUND

This present disclosure generally relates to a medical device that allows users to adjust their cervical vertebra. Particularly, it relates to a wall- or door-mounted traction device that allows a single user to perform cervical traction by adjusting the device. This disclosure also relates to a method of using the traction device.

### SUMMARY

One aspect of the instant disclosure relates to a wall- or door-mounted traction device comprises a rail and a slider. The rail can be mounted on a wall, door, or support. The slider is able to slide along the rail and further comprises a loop that faces away from the rail. The loop may support at least one cord that may be connected to a neck harness. The neck harness is generally placed around a user's upper neck/lower head to provide support thereto. The slider may further comprise a lever that allows to user to adjust the position of the slide on the rail. When using the wall-mounted traction device, the user can put his/her neck in the neck harness. The weight of the user's lower body will create tension on the neck when supported by the neck harness. The users can adjust the height of the neck harness depending on the user's height and posture when in traction. One way to adjust the height of the neck harness is to have the slide move along the rail. One way to have the slide move along the rail is to use the lever to loosen and then fix the slide on the rail.

According to the present disclosure, a traction device is provided. The traction device comprises a rail having a plurality of apertures, a slider body positioned on the rail to move vertically when the rail is mounted on a vertical surface in a vertical position, a harness supported by the slider body and configured to support a head of a user, at least one pin supported by the slider body, and a handle coupled to the at least one pin to move the pin in and out of at least one of the plurality of apertures of the rail permitting movement of the slider body relative to the rail to adjust the position of the harness relative to the rail.

According to another aspect of the present disclosure, a method of providing traction to a user is provided. The method comprising the steps of providing a traction device having a harness configured to support a head of a user and a harness mount supporting the harness on a vertical surface, supporting the head of the user with the harness, and the user adjusting the position of the harness relative to the mount while the head of the user is supported by the harness.

Additional features of the present disclosure will become apparent to those skilled in the art upon consideration of the following detailed description of the illustrative embodiment exemplifying the best mode of carrying out the disclosure as presently perceived.

### BRIEF DESCRIPTION OF THE DRAWINGS

FIG. 1 is a side view of a wall-mounted traction device used by a user;

FIG. 2 is a front view of a wall-mounted plate of the wall-mounted traction device as shown in FIG. 1;

FIG. 3 is a perspective view of the wall-mounted plate of the wall-mounted traction device as shown in FIG. 1;

FIG. 4A is a front view of a rail of the wall-mounted traction device as shown in FIG. 1;

FIGS. 4B and 4C are perspective views of the rail of the wall-mounted traction device as shown in FIG. 1;

FIGS. 5A and 5B are perspective views of a slider of the wall-mounted traction device as shown in FIG. 1;

FIG. 6 is a front view of the slider of the wall-mounted traction device as shown in FIG. 1;

FIG. 7 is a demonstrative front view of the slider of the wall-mounted traction device as shown in FIG. 1; and

FIG. 8 is a cross-sectional view of the slider engaged with the rail of the wall-mounted traction device as shown in FIG. 1.

For the purpose of promoting and understanding of the principals of the disclosure, reference will now be made to the embodiments illustrated in the drawings, which are described below.

The embodiments disclosed below are not intended to be exhaustive or limited to the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alternations and further modifications in the illustrative devices and described methods and further applications of the principles of the disclosure which would normally occur to on skilled in the art to which the disclosure relates. Unless otherwise indicated, the components illustrated in the figures are shown in proportion to each other.

### DETAILED DESCRIPTION

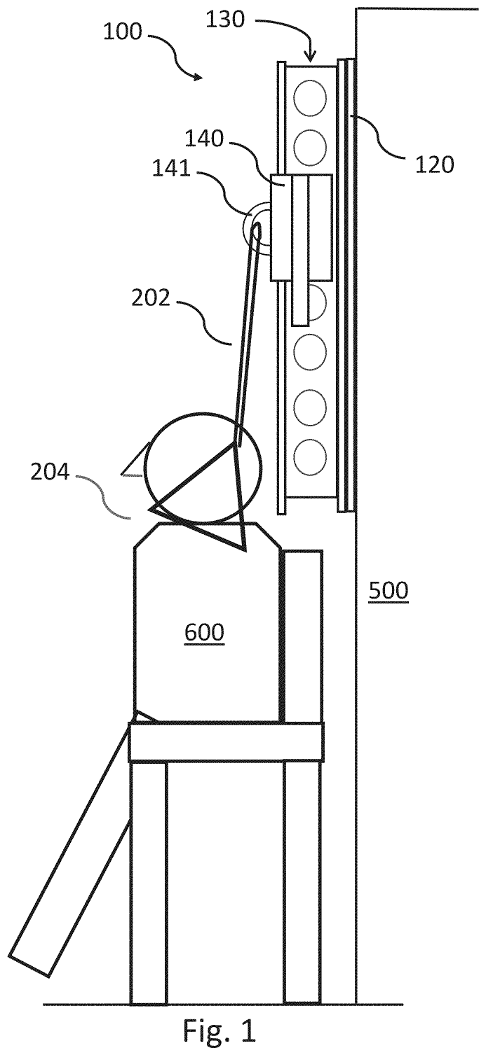

On occasion, it is helpful to place a user 600 in cervical traction. As shown in FIG. 1, a wall-mounted cervical traction device 100 is provided. Wall-mounted traction (or cervical traction) device 100 comprises a rail 130 and a slider 140, collectively referred to as a harness mount. Rail 130 can be mounted on a wall 500 directly or indirectly, a door (not shown), or other support. Slider 140 engages with rail 130 to slide along rail 130. Slider 140 and rail 130 can be made of metal materials (e.g., aluminum or steel), plastic, a combination thereof, or other materials. Device 100 further includes a loop 141 supported by slider 140. Loop 141 may be integrally formed as one piece with slider 140, but loop 141 can also be another piece, such as a metal piece affixed to slider 140. Loop 141 faces away from rail 130. Device 100 further includes a one or more cords 202 supported by loop 141 and a neck harness 204 supported by cord 202. In use, neck harness 204 is placed around a user's upper neck/lower head to provide support thereto. This arrangement allows user 600 to use wall-mounted traction device 100 along with the at least one cord 202 and neck harness 204 for, but not limited to, chiropractic purposes. After neck harness 204 engages with user's 600 neck, user 600 may create traction by support a portion of the user's lower body weight on neck harness 204. For users 600 having different heights and/or weights, the coupling of slider 140 and rail 130 allows users 600 to adjust the height of loop 141 to ensure loop's 141 height is suitable for different users 600. For example, to apply more traction, slider 140 may be moved up relative to rail 130 and to apply less traction, slider 140 may be moved down relative to rail 130.

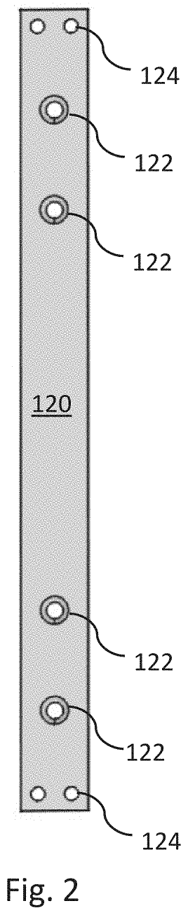

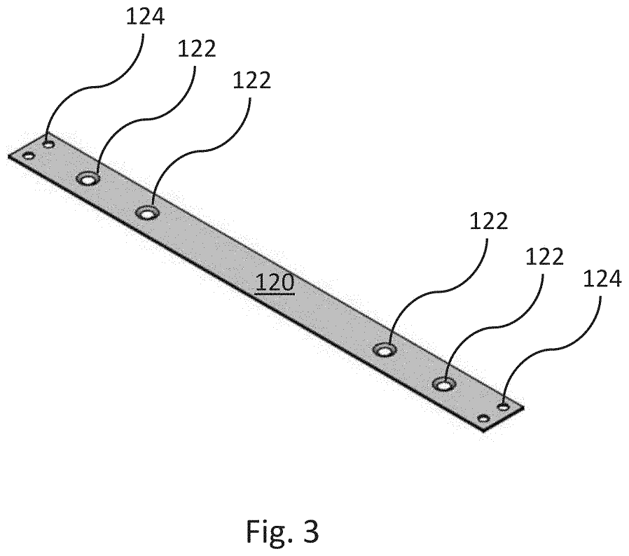

As shown in FIGS. 2 and 3, rail 130 includes a wall-mounted plate 120. Wall-mounted plate 120 may be made of, for example, plastic material and has one or multiple wall-mounting holes 122 arranged along the longitudinal axis of wall-mounted plate 120. Wall-mounting hole(s) 122 are configured to receive fasteners (not shown) to fix wall-mounted plate 120 to wall 500 or another solid foundation. For example, wall-mounting holes 122 are configured to receive bolts or screws (not shown) that go into wall 500 to fix wall-mounted plate 120 onto wall 500. Wall-mounting holes 122 may have a counter-sunk edge (as shown in FIG. 3) to create better engagement with the bolts or screws. As shown in FIG. 3, the edges of wall-mounting holes 122 edges get thinner from the outer edges to the inner edges. Wall-mounted plate 120 further includes at least one rail-engaging hole(s) 124. Rail-engaging holes 124 are arranged to align with corresponding holes 134 in rail 130 (as shown in FIG. 1) so that rail 130 can be affixed to wall-mounted plate 120 and/or wall 500. For example, one or more screws or bolts (not shown) may extend through rail 120 and rail-engaging holes 124 to fix them together on to wall 500. Rail-engaging holes 124 may be located at two ends of wall-mounted plate 120 and each end may have a pair of rail-engaging holes 124. Other arrangements and numbers of holes 122, 124 may also be provided.

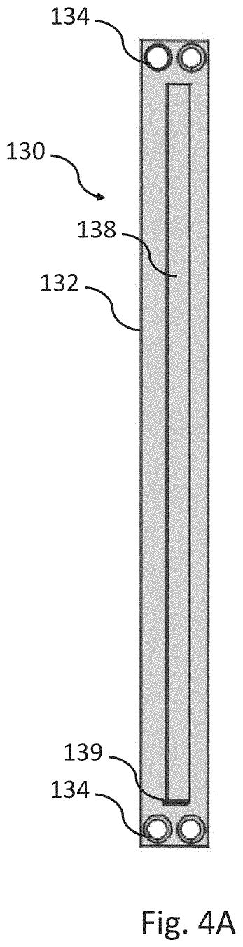

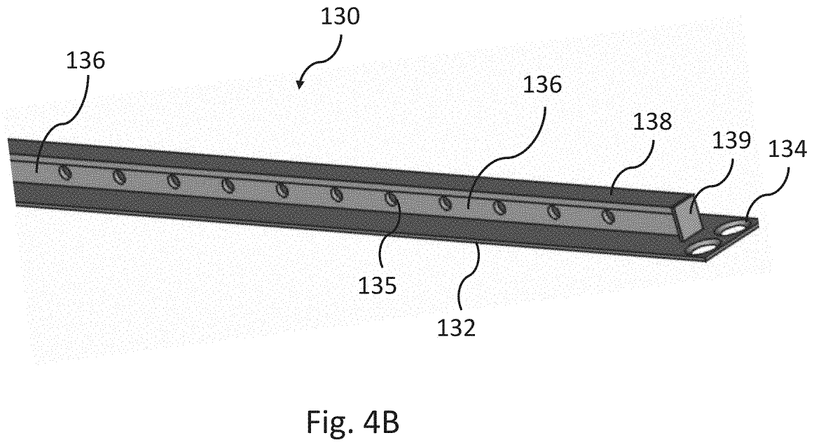

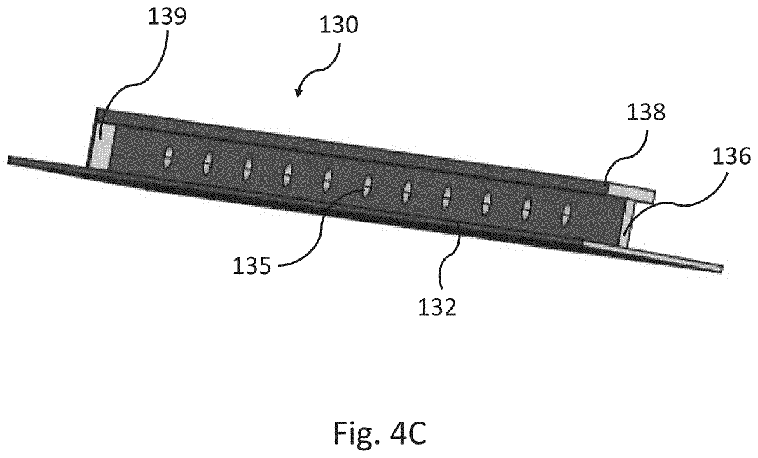

As shown in FIGS. 4A and 4B, rail 130 may include a bottom plate 132, a top plate 138, and a slide rail 136 (as shown in FIG. 4B). Rail 130 may have plate-engaging holes 134 positioned in bottom plate 132. Plate-engaging holes 134 are arranged correspondingly to (e.g., overlapping with) rail-engaging holes 124, and thereby, screws or bolts (not shown) can go through plate-engaging holes 134 on rail 130 and rail-engaging holes 124 on wall-mounted plate 120. Slide rail 136 has multiple slide lock holes 135 arranged along the longitudinal axis of rail 130. Slide rail 136 is positioned between bottom plate 132 and top plate 138 along a direction perpendicular to bottom plate 132 and top plate 138. Bottom plate 132 and top plate 138 may be parallel to each other. Slide rail 136 may be perpendicular to bottom plate 132 and top plate 138. The width of slide rail 136 is smaller than the width of bottom plate 132 and top plate 138 along a direction perpendicular to the longitudinal axis of rail 130. The width of top plate 138 is smaller than the width of bottom plate 132 along a direction perpendicular to the longitudinal axis of rail 130. Roughly, the combination of slide rail 136, bottom plate 132, and top plate 138 renders the cross-section of rail 130 in an I-shape. Rail 130 may further include an end wall 139 located at least one end of rail 130. End wall 139 may be located at the bottom end (when rail 130 is mounted on a wall) of rail 130. End wall 139 may prevent slider 140 from sliding off rail 130. The width of end wall 139 may be substantially identical to the width of top plate 138.

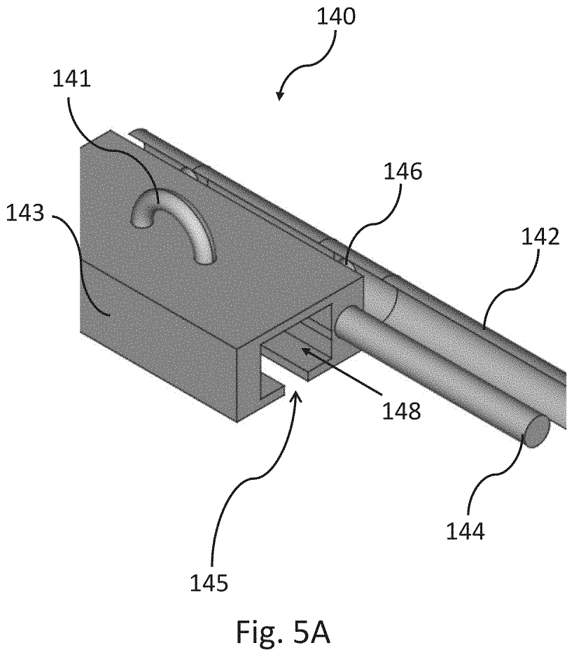

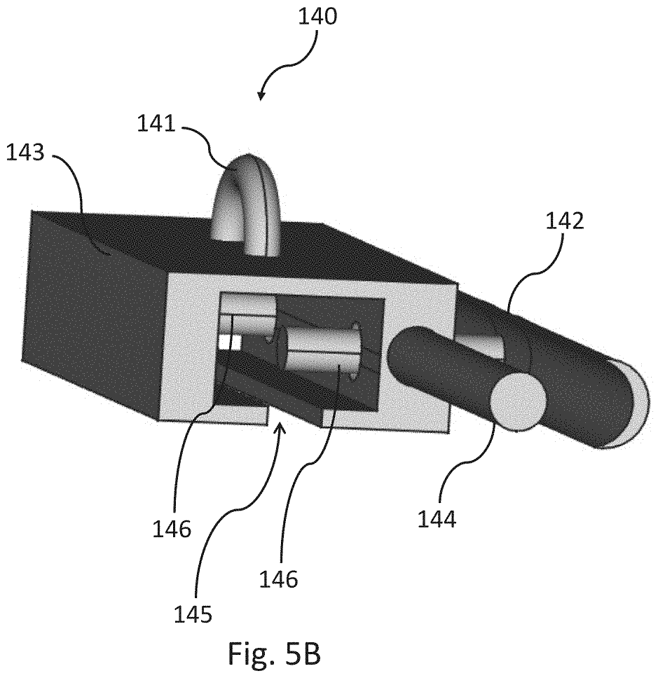

As shown in FIGS. 5A and 5B, slider 140 includes loop 141 and a slider body 143 supporting loop 141. Slider body 143 may be cubic and hollow. Slider body 143 includes an opening 148 (as shown in FIG. 5A) on one of the lateral walls. Another similar opening (not shown) is formed on the opposite lateral wall, and thereby, rail 130 may go through slider body 143, allowing slider 140 to slide along rail 130.

Slider 140 may further include a lever 142 posited at one side of slider body 143. Lever 142 may be longer than slider body 143. One or more locking pins 146 (as shown in FIG. 5B) are coupled (directly or indirectly) to lever 142. Locking pins 146 are positionable to move laterally in slot 145 defined by slider body 143. Locking pins 146 may be cylindrical or other shapes. The position of locking pins 146 can be controlled by manipulating lever 142, such that lever 142 can draw locking pins 146 in and out of the concave opening of slider body 143 directly or indirectly.

Slider 140 may further include a handle 144 extending from a lateral wall with opening 148 (shown in FIG. 5A). Handle 144 may be, but not necessarily, substantially parallel to lever 142 and is cylindrical or another shape.

Slot 145 is preferably located on a side of slider body 143 opposite to loop 141. Slot 145 is positionable to house slide rail 136 (as shown in FIGS. 4B and 4C). Yet, the width of the opening of slot 145 may be smaller than the width of top plate 138 and the width of end wall 149 (as shown in FIGS. 4B and 4C), and thereby, slider 140 is prevented from being pulled off of rail 130.

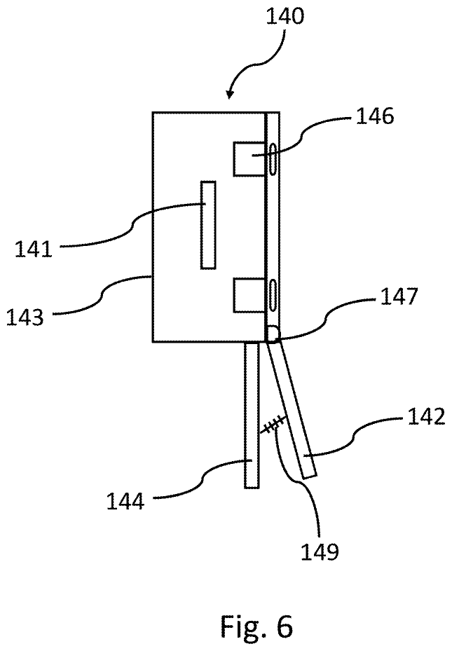

As shown in FIG. 6, which is a front view of slider 140 of wall-mounted traction device 100 as shown in FIG. 1, slider 140 may further include a pivot hinge 147. Lever 142 may pivot relatively to slider body 143 about pivot hinge 147, and thereby, the position of locking pins 146 may be adjusted. Pivot hinge 147 is preferably be coupled to slider body 143 and lever 142. Pivot hinge 147 is preferably located on a lateral wall of slider body 143 facing lever 142. Pivot hinge 147 may be located at an end of the lateral wall of slider body 143 close to lever 142, but it can also be located at the opposite end of the lateral wall distant front lever 142 or any other suitable location.

As shown in FIG. 6, slider 140 may further include a spring 149 configured to maintain the position of lever 142. Spring 149 is coupled to lever 142 and may be further coupled to handle 144 or other part(s) of slider 140. Spring 149 can be a coil spring, plate spring, compression spring, tension spring, torsion spring, Belleville spring, and/or other elastic materials. Thereby, when lever 142 is pressed, locking pins 146 would move outwardly from slider body 143. When the pressure is released, spring 149 push lever 142 back to the original position, and locking pins 146 would move inwardly toward slider body 143 to their original position.

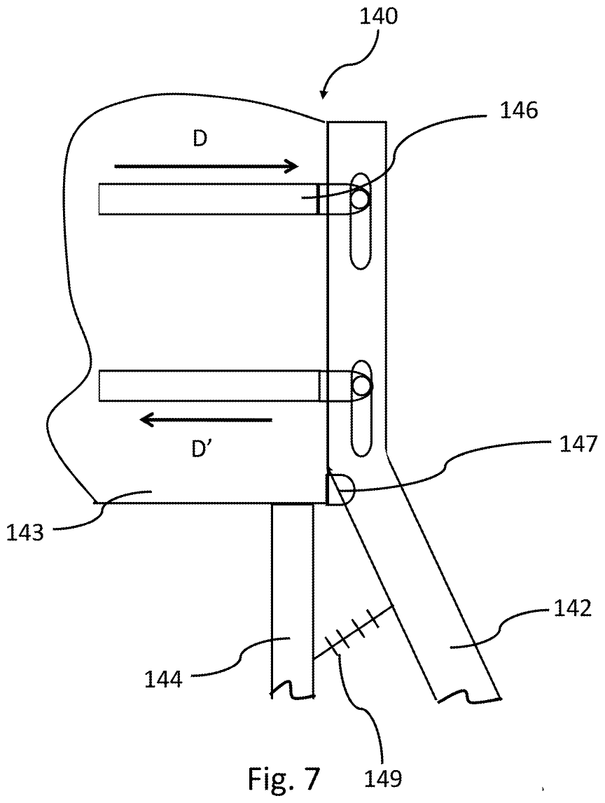

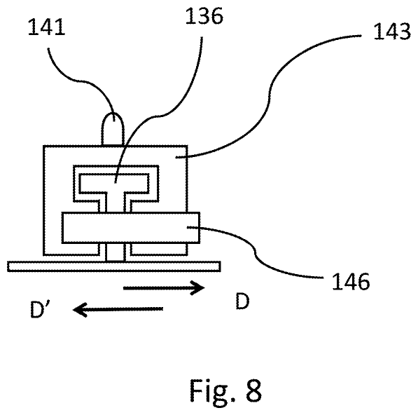

FIG. 7 is a demonstrative front view of slider 140 of wall-mounted traction device 100 as shown in FIG. 1. FIG. 8 is a cross-section view of slider 140 engaged with rail 120 of wall-mounted traction device 100 as shown in FIG. 1. When lever 142 is pressed, locking pins 146 are drawn to move along direction D and outwardly from slider body 143. Thereby, locking pins 146 would be detached from slider lock holes 135 (as shown in FIGS. 4B and 4C), and then slider 140 can slide along rail 130 to adjust the height of loop 141 for different users 600. When lever 142 is released from the pressure, locking pins 146 move along the opposite direction D′ and inwardly toward slider body 143. The locking pins 146 again return inward to a potentially new position to engage with (for example, go through) slider locking holes 135 (as shown in FIGS. 4B and 4C), and the movement of slider 140 are substantially disabled.

In use, user 600 can adjust the position of slider 140 to increase or decrease the tension in cord 202 so that the amount of traction applied to user 600 increases or decreases while seated on a chair or other device and wearing harness 204. User 600 can reach up and grab lever 142 to release slider 140 and adjust the position thereof. Thus, user 600 can adjust the traction while remaining seated and wearing harness 204.

What is claimed is:

1. A traction device comprising
a rail having a plurality of apertures,
a slider body positioned on the rail to move vertically when the rail is mounted on a vertical surface in a vertical position,
a harness supported by the slider body and configured to support a head of a user,
at least one pin supported by the slider body, and
a handle coupled to the at least one pin to move the pin in and out of at least one of the plurality of apertures of the rail permitting movement of the slider body relative to the rail to adjust the position of the harness relative to the rail.

2. A method of providing traction to a user, the method comprising the steps of
providing a traction device having a harness configured to support a head of a user and a harness mount supporting the harness on a vertical surface,
supporting the head of the user with the harness, and
the user adjusting the position of the harness relative to the mount while the head of the user is supported by the harness.

3. The method of claim 2, further comprising the step of
the user moving to a seated position and the user adjusting step occurs while the user is in the seated position.

4. The method of claim 3, further comprising the step of
the user grasping a handle of the traction device to disengage a slider body of harness mount from a rail of the harness mount and the user adjusting step occurs while the user grasp the handle.
